(19) United States
(12) Patent Application Publication
(10) Pub. No.: US 2025/0271105 A1
(43) Pub. Date: Aug. 28, 2025

(54) PRESSURE VESSEL BOSS FOR A ROTO-MOLDED LINER

(71) Applicant: Hexagon Technology AS, Alesund (NO)

(72) Inventors: Brian Christopher Yeggy, Lincoln, NE (US); Michael Gregory Volkmer, Lincoln, NE (US)

(21) Appl. No.: 19/053,753

(22) Filed: Feb. 14, 2025

Related U.S. Application Data
(60) Provisional application No. 63/556,454, filed on Feb. 22, 2024.
(60) Provisional application No. 63/750,332, filed on Jan. 28, 2025.

(51) Int. Cl. F17C 13/00

(52) U.S. Cl. CPC F17C 13/002; F17C 2201/0109; F17C 2203/0604; F17C 2203/0629; F17C 2205/0305; F17C 2209/2145

(57) ABSTRACT

A boss is configured for attachment to a liner of a pressure vessel. The boss includes a port, a neck and a flange. The port has a longitudinal axis and connects an interior and exterior of the pressure vessel. The flange includes an outer edge at a farthest radial extent from the longitudinal axis; an exterior side on a first side of the outer edge; and an interior side on an opposed second side of the outer edge. The interior side includes a first radially inner annular groove and a second radially outer annular groove. Each of the first and second annular grooves has a width at its opening that is equal to or greater than a width at its base. An assembly includes a liner having a first opening and a first boss attached to the liner at the first opening.

### CROSS-REFERENCE TO RELATED APPLICATION

This application claims the benefit of priority from U.S. Provisional Application No. 63/556,454, filed Feb. 22, 2024. This application also claims the benefit of priority from U.S. Provisional Application No. 63/750,332, filed Jan. 28, 2025. The priority applications are hereby incorporated by reference in their entireties.

### BACKGROUND

Pressure vessels are commonly used for containing a variety of fluids under pressure, such as storing oxygen, natural gas, nitrogen, propane and other fuels, for example. Suitable container materials include laminated layers of wound fiberglass filaments or other synthetic filaments bonded together by a thermal-setting or thermoplastic resin. An elastomeric or other non-metal resilient liner or bladder often is disposed within the composite shell to seal the vessel and prevent internal fluids from contacting the composite material. The composite construction of the vessels provides numerous advantages such as lightness in weight and resistance to corrosion, fatigue and catastrophic failure. These attributes are primarily due to the high specific strengths of the reinforcing fibers or filaments that are typically oriented in the direction of the principal forces in the construction of the pressure vessels.

FIGS. 1 and 2 illustrate an elongated pressure vessel 10, such as that disclosed in U.S. Pat. No. 5,476,189, which is hereby incorporated by reference. Vessel 10 has a main body section 12 with end sections 14. A boss 16 is provided at one or both ends of the vessel 10 to provide a port for communicating with the interior of the vessel 10. The vessel 10 is formed from an inner polymer liner 20 covered by an outer composite shell 18. In this disclosure, “composite” means a fiber reinforced resin matrix material, such as a filament wound or laminated structure.

The liner 20 has a generally hemispheroidal end section 22 with an opening 24 aligned within an opening 26 in the outer composite shell 18. Boss 16 is positioned within the aligned openings and includes a neck portion 28 and a radially outwardly projecting flange portion 30. The boss 16 defines a port 32 through which fluid at high pressure may be communicated with the interior of the pressure vessel 10.

Liner 20 includes a dual layer lip circumscribing opening 24 in the liner 20, with an exterior lip segment 34 and an interior lip segment 36 defining an annular recess 38 therebetween for receiving flange portion 30 of boss 16. Dovetailed inter-engaging trap locks 40 are provided between flange portion 30 and exterior and interior lip segments 34 and 36, respectively, to lock liner 20 to boss 16.

This type of interlocking liner and boss structure is quite effective when the liner is formed by injection molding. However, the structure is not ideal for liners that are formed in a rotational molding process, which results in a liner having relatively uniform thickness. One prior roto-molded tank seal is disclosed in U.S. Pat. No. 7,837,054 by Van Oyen, assigned to Quantum Fuel Systems Technologies Worldwide, Inc. of Irvine, California. The Van Oyen tank seal uses a multiple piece assembly that holds a radial seal (o-ring) 63 between a liner 61 and a boss member 64, resulting in complexity in assembly and use.

### SUMMARY

In one aspect, a boss is configured for attachment to a liner of a pressure vessel. The boss comprises a port, a neck and a flange. The port has a longitudinal axis and is configured to connect an interior of the pressure vessel and an exterior of the pressure vessel. The neck circumscribes an exterior portion of the port. The flange circumscribes an interior portion of the port and extends radially outward from the neck. The flange comprises an outer edge at a farthest radial extent from the longitudinal axis; an exterior side disposed on a first side of the outer edge; and an interior side disposed on an opposed second side of the outer edge. The interior side comprises a first radially inner annular groove and a second radially outer annular groove positioned at a greater distance from the longitudinal axis than the first radially inner annular groove. The first radially inner annular groove has a first width at its first base and a second width at its first opening, wherein the second width is equal to or greater than the first width. The second radially outer annular groove has a third width at its second base and a fourth width at its second opening, wherein the fourth width is equal to or greater than the third width. In another aspect, an assembly comprises a liner comprising a first opening and first boss attached to the liner at the first opening.

This summary and the Abstract are provided to introduce concepts in simplified form that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE DRAWINGS

The disclosed subject matter will be further explained with reference to the attached figures, wherein like and analogous structure or system elements are referred to by like reference numerals, or numbers indexed by 100, throughout the several views. All descriptions are applicable to like and analogous structures throughout the several embodiments, unless otherwise specified.

FIG. 1 is a side elevation view of a typical elongated pressure vessel.

FIG. 2 is a partial cross-sectional view through one end of such a pressure vessel, taken along line 2-2 of FIG. 1.

FIG. 3 is a cross-sectional perspective view of a conventional boss.

FIG. 4 is a cross-sectional perspective view of a first embodiment of a boss of the disclosure.

FIG. 5 is a partial cross-sectional perspective view of the first embodiment of the boss, as viewed from the right side of FIG. 4.

FIG. 6 is a partial cross-sectional view through half of one end of a pressure vessel liner formed by roto-molding with the first embodiment of the boss.

FIG. 7 is similar to FIG. 6 but shows a second embodiment of a boss of the disclosure.

FIG. 8 is a cross-sectional perspective view of a pressure vessel having the second embodiment of a boss disposed at both opposed ends.

FIG. 9 is an enlarged view of the encircled portion “9” of FIG. 8.

FIG. 10 is a partial cross-sectional view of the sealing portion of a third embodiment of a boss of the disclosure.

FIG. 11 is an enlarged view of the encircled portion “11” of FIG. 10.

FIG. 12 is an interior end view of an exemplary boss of the disclosure, having six relatively narrow slots for a liner anchor.

FIG. 13 is an interior end view of an exemplary boss of the disclosure, having eight relatively narrow slots for a liner anchor.

FIG. 14 is an interior end view of an exemplary boss of the disclosure, having eight relatively wider slots for a liner anchor.

FIG. 15 is a partial cross-sectional view through half of one end of a pressure vessel liner formed by roto molding, illustrating radial shrinkage of the liner material about the exemplary pressure vessel boss.

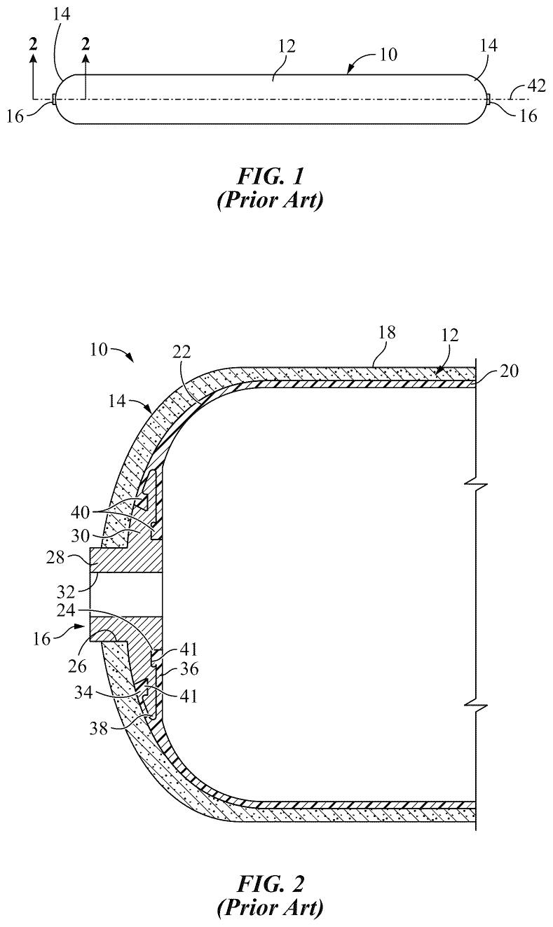

While the above-identified figures set forth one or more embodiments of the disclosed subject matter, other embodiments are also contemplated, as noted in the disclosure. In all cases, this disclosure presents the disclosed subject matter by way of representation and not limitation. It should be understood that numerous other modifications and embodiments can be devised by those skilled in the art that fall within the scope of the principles of this disclosure.

The figures may not be drawn to scale. In particular, some features may be enlarged relative to other features for clarity. Moreover, where terms such as above, below, over, under, top, bottom, side, right, left, vertical, horizontal, etc., are used, it is to be understood that they are used only for ease of understanding the description. It is contemplated that structures may be oriented otherwise.

The terminology used herein is for the purpose of describing embodiments, and the terminology is not intended to be limiting. Unless indicated otherwise, ordinal numbers (e.g., first, second, third, etc.) are used to distinguish or identify different elements or steps in a group of elements or steps and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. Unless indicated otherwise, any labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” “intermediate” and the like are used for convenience and are not intended to imply, for example, any particular fixed location, orientation, or direction. Instead, such labels are used to reflect, for example, relative location, orientation, or directions. The singular forms of “a,” “an,” and “the” include plural references unless the context clearly dictates otherwise.

### DETAILED DESCRIPTION

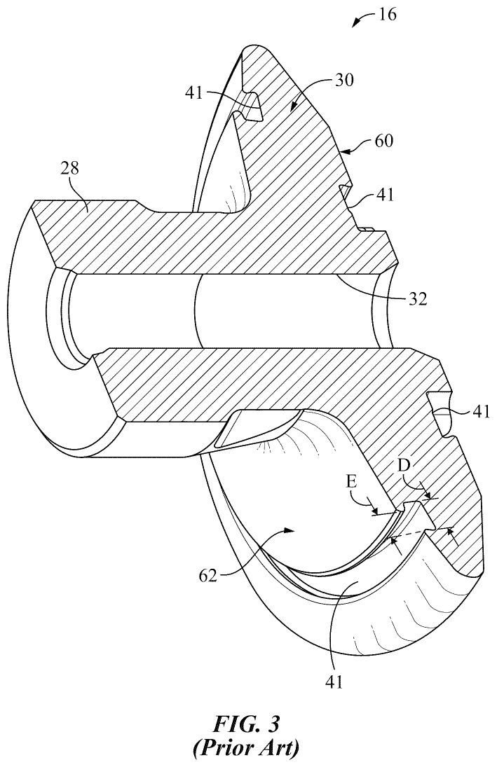

Referring to FIGS. 2 and 3, when a liner 20 is formed by injection molding, molten polymer material can be made to flow around the structures of boss 16, such as flange 30, to fill in the recesses therein to form exterior lip segment 34, interior lip segment 36, and trap locks 40. As shown in FIG. 2, the thickness of liner 20 around these various features is not uniform. For example, thicker deposits of liner material make up the trap locks 40 that fill grooves 41, as well as the area 38 at the radially distal end of flange 30; other areas of liner 20 are thinner, such as at exterior lip segment 34, interior lip segment 36, and main body section 12. Another boss and liner interface is described in commonly owned U.S. Pat. No. 9,644,790 by Newhouse for “Pressure Vessel Boss and Liner Interface,” which is hereby incorporated by reference.

A liner can also be formed by a rotational molding (also referred to as roto-molding) process that uses a roto-molding machine. An exemplary roto-molding liner manufacturing process involves introducing powder resin into a mold cavity of the machine and heating the powder to a specific temperature to liquefy it. The mold is then rotated to coat the resin in a layer on all sides of the interior of the mold and a boss attached to the mold. This layer is allowed to cure to result in a hollow resin structure. In a case in which a multiple layer structure of a liner is desired, the process can be repeated for each layer. Because formation of a liner by roto-molding builds up the liner by coating the mold cavity with the molten resin, the resulting liner generally has a uniform thickness around the inside of the mold and around structures of the boss around which the liner is formed. This disclosure describes exemplary embodiments of a pressure vessel boss 116 that is particularly configured for effective sealing in a pressure vessel 10 having a liner 120 formed by rotational molding.

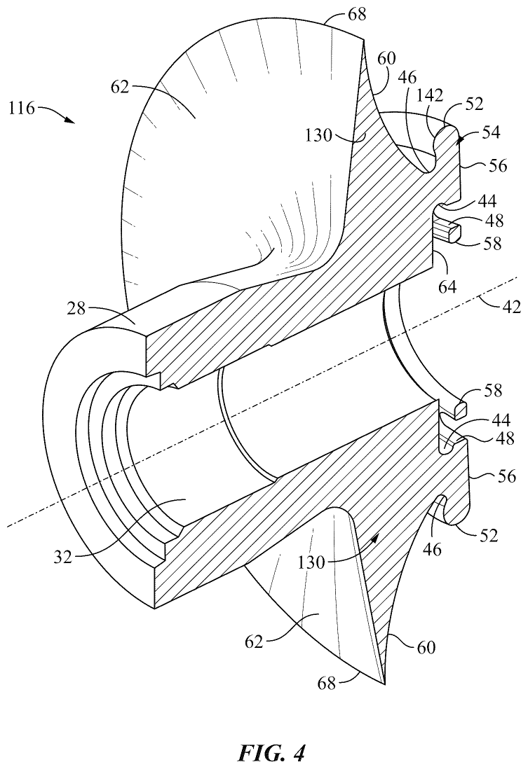

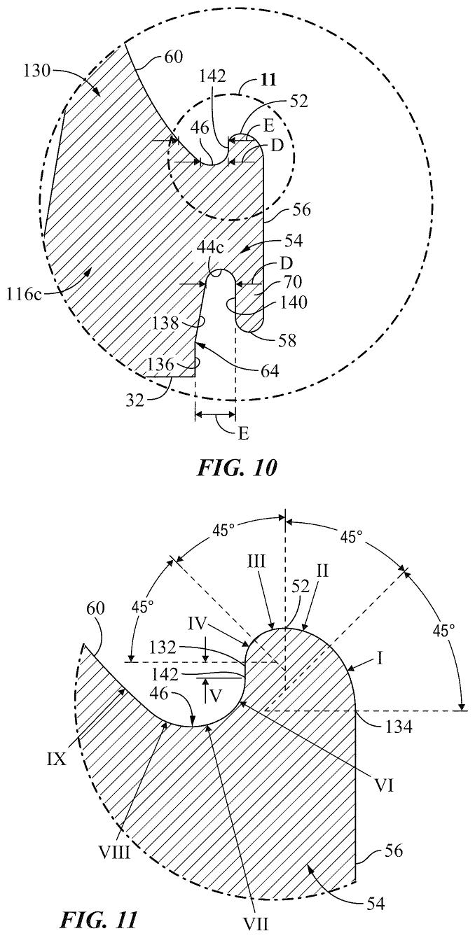

FIGS. 4-15 illustrate exemplary embodiments of a boss 116 configured for use with a roto-molded liner 120. Three specific embodiments of a pressure vessel boss 116 are described, and in some cases they will be differentiated by referring to the first embodiment with reference number 116a (FIGS. 4-6), the second embodiment with reference to number 116b (FIGS. 7-9), and the third embodiment with reference to number 116c (FIGS. 10 and 11). However, in many aspects, the structures are similar; descriptions of boss 116, 116a, 116b or 116c apply to all embodiments unless otherwise specified. This convention also applies to other similarly numbered elements.

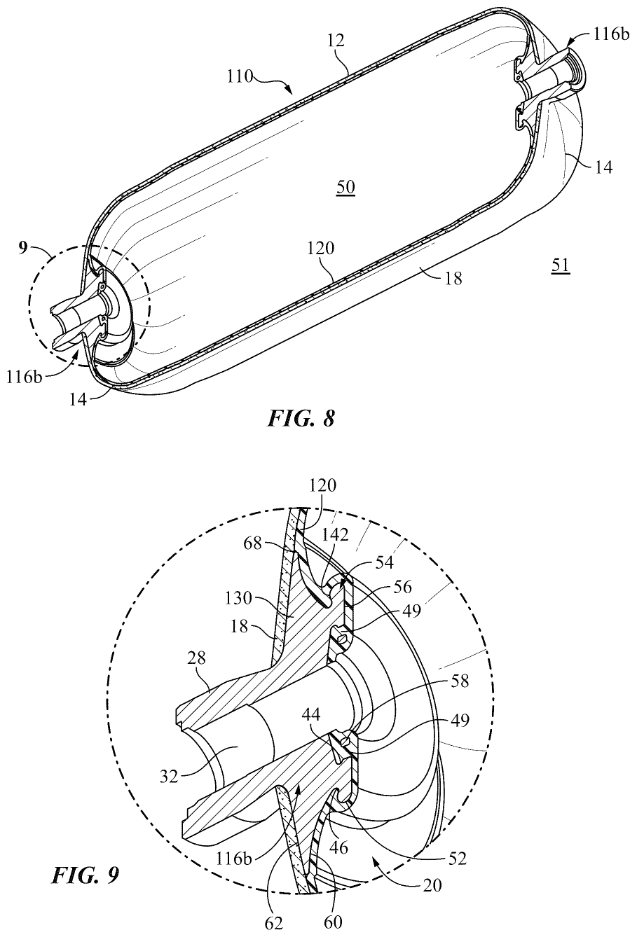

Referring to FIG. 8, in an exemplary embodiment, a liner 120 and its associated boss 116 together form a portion of a pressure vessel 110 having an interior environment 50 and an exterior environment 51. Structures such as surfaces designated as “interior” or “exterior” will have orientations relative to the interior environment 50 and the exterior environment 51. For example, flange 130 has an interior surface 60 and an exterior surface 62 (labeled in FIG. 9 for example).

While only portions of a boss 116, liner 120 and shell 18 of pressure vessel 110 are illustrated in some figures, so that their structures are more clearly visible, it is to be understood that each of the boss 116, liner 120, shell 18 and associated pressure vessel structures is annular in shape, with half of the structures shown in FIGS. 4, 8 and 9, for example. In exemplary embodiments, the boss 116 is rotationally symmetrical, so that the unillustrated portion is a mirror image of the illustrated half. In an exemplary method for forming liner 120 in a roto-molding machine, the boss 116 is placed in the molding chamber so that edge 68 contacts the mold cavity surface, and the liner material does not form on the exterior surface 62 of flange 130.

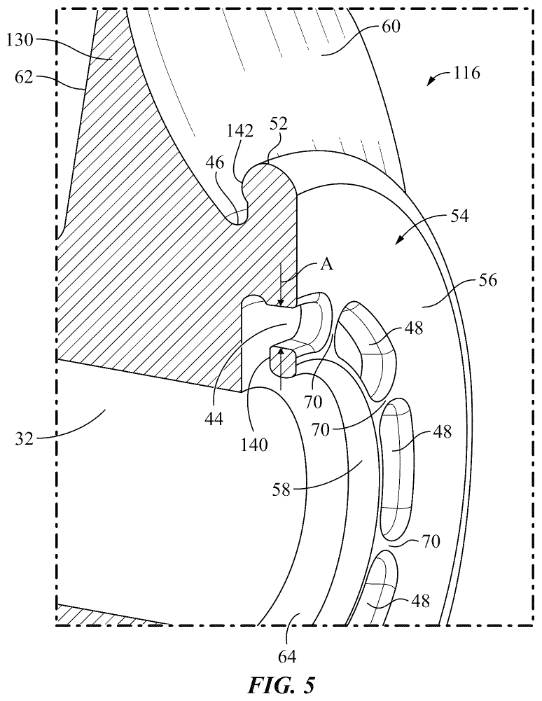

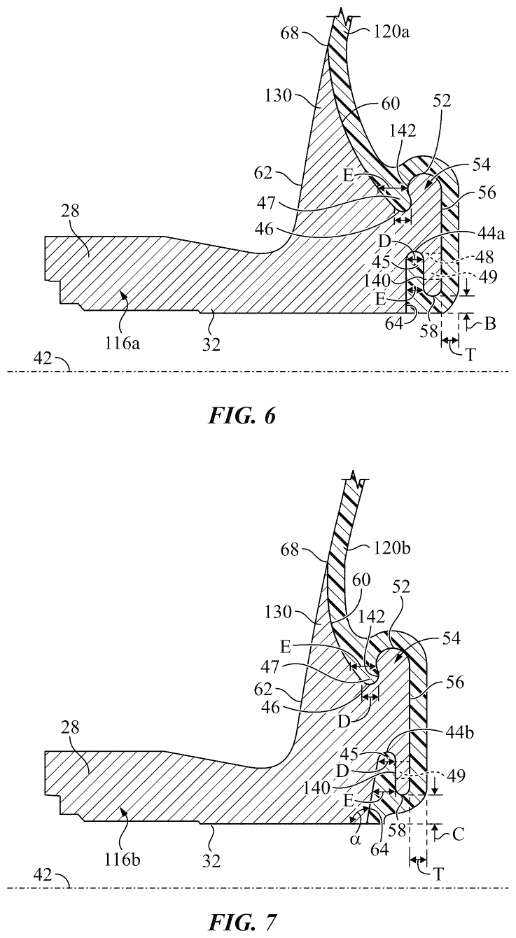

In an exemplary embodiment, as shown in FIGS. 4-6, in a first exemplary embodiment of a boss 116a, ridge 54 extends interiorly of flange 130 and provides a structure on and through which liner 120a is secured to boss 116a. In an exemplary embodiment, annular groove 44 is provided on boss 116a between flange 130 and interior surface 56, into which the liner material may flow to form an interlocking bead 45 of liner 120 (labeled in FIG. 6). Groove 44 extends generally radially outwardly from axis 42 of boss 116 and of a pressure vessel 110 formed thereon. In an exemplary embodiment, ridge 54 includes radially inner annular lip 58 extending in a radial direction inwardly to prevent separation of boss 116 and liner 120 in the axial direction (along axis 42). In an exemplary embodiment, a generally annular groove 46 is disposed between interior surface 60 of flange 130 of boss 116 and ridge 54, and disposed radially outwardly from groove 44. In an exemplary embodiment, radially outer annular lip 52 extends in a radial direction outwardly from annular groove 46, also to prevent separation of boss 116 and liner 120 in the axial direction (along axis 42).

Referring to FIG. 6, during a rotational molding process, liner material flows into the groove 44 and the groove 46, and around their respective annular lips 58 and 52 to form interlocking beads 45 and 47 (on the boss surfaces and within grooves 44 and 46 of boss 116) to prevent separation of boss 116 and liner 120 in the axial direction. Referring to FIG. 5, in an exemplary embodiment, the radially extending lips 52 and 58 of ridge 54 are connected by bridges 70 between apertures 48. In an exemplary embodiment, the interior surface 60 of flange 130 approaches groove 46 at about a 45 degree angle. In an exemplary embodiment, groove 46 is smoothly radiused; in the illustrated examples of bosses 116a and 116b, groove 46 undercuts the lip 52 so that bead 47 is locked in place both radially and axially.

FIGS. 4 and 5 are partial cross-sectional perspective views of a first embodiment of an exemplary boss 116 without the liner formed thereon. As shown in FIG. 5, in an exemplary embodiment, a plurality of discrete apertures 48 extend through interior surface 56 to connect to groove 44 radially outward of inner lip 58. Though apertures 48 are illustrated as substantially oval in shape, they may be circular, polygonal, or have any other shape. In addition, though apertures 48 are illustrated as circularly disposed about annular lip 58, they maybe otherwise located to connect groove 44 and interior surface 56.

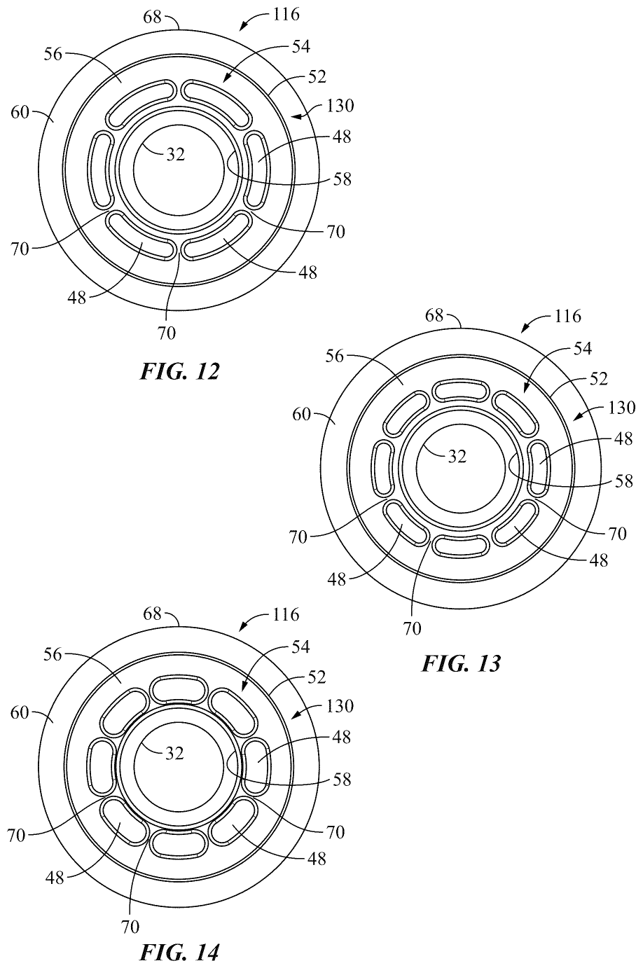

FIGS. 12, 13 and 14 show interior end views of embodiments of an exemplary boss 116 having different variations in the configurations of apertures 48. For example, FIG. 12 shows six relatively narrow apertures 48. In exemplary embodiments, the plurality of apertures 48 are evenly spaced about the circumference of ridge 54, but they need not be so arranged. FIG. 13 shows eight relatively narrow apertures 48. FIG. 14 shows eight relatively wide apertures 48. While only a few different configurations of apertures are illustrated herein, it is to be understood that they can be provided in numbers and shapes other than illustrated. The sizes, locations and shapes of apertures 48 determine the structure of anchors 49 of liner material formed therein. Thus, larger (by volume) apertures 48 lead to more robust anchors 49; this consideration should be balanced with the strength of ridge 54, which is maximized with smaller apertures 48.

Referring to FIGS. 4, 6-9 and 15, in exemplary embodiments, flange 130 is shaped so that the interior surface 60 and exterior surface 62 taper together and meet at a perimeter edge 68 that contacts an interior surface of the molding chamber of the roto-molding machine. Accordingly, liner material smoothly coats the interior surface 60 of the flange 130 and continues (radially outwardly relative to axis 42) onto the interior of the mold cavity. A roto-molding method of forming liner 120 includes allowing a fluid polymer material for liner 120 to coat the interior surfaces of boss 116, including interior flange surface 60, groove 46, around lip 52, on interior surface 56, into and around apertures 48, around lip 58 and groove 44. Each layer of liner material cures and solidifies on those surfaces of boss 116 and the interior surfaces of the mold chamber, as the liner 120 and boss 116 assembly are joined together by such a roto-molding process.

In some embodiments, additional layers of liner material are roto-molded onto the previously cured layers to build up a liner 120 that has substantially uniform thickness around all the mold and internal boss surfaces. In FIG. 6, a total thickness T of a completed liner 120 is shown. In an exemplary embodiment, a dimension of each of grooves 44 and 46 in the axial direction (along axis 42) ranges from substantially equal to T to preferably no greater than twice T. Moreover, in an embodiment, dimension B in FIG. 6, a radially extending distance (normal to axis 42 between lip 58 and the bore surface 32) is substantially equal to T. Typically, a radially inner surface (bottom of dimension B as illustrated) is molded against a mandrel that holds the boss 116 in a roto-molding machine. Preferably, B is no smaller than T as illustrated; the area between lip 58 and a mandrel, valve or plug that would be inserted into port 32 should not fill with liner material before groove 44 is completely filled with liner material. Additionally, as shown in FIG. 5, in an exemplary embodiment a width of the aperture 48, designated as dimension A (in a radial dimension relative to axis 42), is no greater than twice the thickness T, so that the liner material fully fills the aperture 48, forming anchor 49 (see FIG. 9) of liner material. Sizing the structures of boss 116 in this manner prevents the formation of empty pockets around the boss 116 that are void of liner material.

Each of the grooves 44a, b, c and 46a, b, c is configured for successful rotational molding, being formed with a width at groove base D that is less than or equal to a width at groove opening E. In exemplary embodiments, each groove is smoothly curved at its closed base. In this disclosure, the width at groove base D is considered to be a primary base width outside of the radiused end. The width at opening E is taken in a plane parallel to the width at groove base D. The width measurement planes are considered to be substantially parallel to the layer orientations of roto-molded layers of liner material that are deposited onto the closed bases of each of the grooves 44a, b, c and 46a, b, c.

Referring to FIG. 6, in boss 116a at radially inner groove 44a, the width E at the groove opening is substantially equal to the width D at the groove base. Referring to FIG. 7, in boss 116b at radially inner groove 44b, the width E at the groove opening is greater than the width D at the groove base, increasing along a radial length of the groove 44b at a linear rate. Referring to FIG. 10, in boss 116c at radially inner groove 44c, the width E at the groove opening is greater than the width D at the groove base, increasing along a radial length of the groove 44b at a non-linear rate (floor 64 has an inclined outer radial portion 138 and a straight inner radial portion 136). Other groove variations are possible, preferably with no area in which a width near the groove opening is narrower than a width near the groove base, to prevent the formation of liner voids during rotational molding.

In contrast, in the prior art boss 16 of FIGS. 2 and 3, the dovetail joint configuration of each of grooves 41 has a groove base width D that is greater than the groove opening width E. Thus, when a liner 20 is roto-molded onto such a boss 16, layers of liner material are likely to build up and close the smaller groove opening at E, likely leaving a void in the larger groove 41, thereby creating undesirable discontinuities in the liner 20.

This potential problem is avoided with the disclosed bosses 116, in which grooves 44, 46 continuously increase in dimension from base width D toward opening width E (or at least do not narrow in dimension from the groove base toward the groove opening). When liner 120 is fully formed, the liner material fills in groove 44, groove 46 and apertures 48, thereby creating annular beads 45, 47 and anchors 49, respectively. Liner 120 is thus mechanically interlocked with boss 116 by anchors 49 formed within apertures 48, connecting the liner material on interior surface 56 with the liner material in groove 44 (bead 45). Accordingly, even under extreme pressure conditions, separation of liner 120 from boss 116 is prevented. In effect, the liner material 120 would tear apart before separation of liner 120 and boss 116 could occur.

In an exemplary embodiment, each anchor 49 contacts only the interior side of the boss 116 (such as to the right of edge 68 in FIGS. 6 and 7) and does not contact the exterior side of the boss 116 (such as to the left of edge 68 in FIGS. 6 and 7). Because groove 44, groove 46 and apertures 48 are all located on the interior side of boss 116, there is no passage for gas leakage from the interior side of boss 116 (facing the interior environment 50 of the liner 120) to the exterior side of boss 116 (facing the exterior environment 51 of the liner 120). Moreover, any built-up gas between liner 120 and boss 116 can escape back into vessel 10 at port 32 of boss 116, thereby preventing a rupture or separation at the interface of liner 120 and boss 116. In an exemplary embodiment as shown in FIGS. 8 and 9, pressure vessel 110 includes filament-wound outer shell 18 over liner 120 and exterior surface 62 of flange 130 of boss 116.

As shown in FIGS. 7-9, in a second exemplary embodiment of a boss 116b, lip 58 of ridge 54 is positioned at a greater distance from bore 32 compared to the first exemplary embodiment of a boss 116a of FIGS. 4-6. For example, dimension C, a radially extending distance (normal to axis 42 between lip 58 and the bore surface 32), is greater than T; in this case, the area between lip 58 and a mandrel disposed in port 32 is not fully filled with liner material.

Another difference between boss 116b and boss 116a is that floor 64 is provided at about a 100 degree obtuse angle alpha relative to port surface 32, rather than a right angle as in boss 116a. This wider entry to the groove 44 may prevent voids from forming in the liner material as the liner 120 is roto-molded onto the interior side of boss 116b.

FIGS. 10 and 11 show cross-sectional partial slices of the sealing portion around ridge 54 of a third exemplary boss 116c, which is in some respects similar to boss 116b described above. In boss 116c, floor 64 has a radially inner portion 136 that is at a right angle to port surface 32 and a radially outer portion 138 that is provided at about a 170 degree obtuse angle relative to radially inner portion 136. This wider entry to the groove 44c may prevent voids from forming in the liner material as the liner 120 is roto-molded onto the interior side of boss 116c.

Referring to FIG. 11, the curvatures of portions of the ridge 54 and groove 46 are not uniform. For example, as interior surface 60 of flange 130 approaches the valley of groove 46 (from left to right), the extent of curvature of that surface increases (that is, the theoretical radius of the curvature is smaller or tighter) until an inflection point 132 between the concave surface of groove 46 and the convex surface of lip 52. On the convex surface of lip 52, the theoretical radius increases (the extent of curvature decreases—the curvature becomes more gradual) around the lip 52 from the inflection point 132 to a second inflection point 134 between the lip 52 and the straight portion of interior surface 56.

On FIG. 11, exemplary changes in effective curvature are illustrated in 45 degree arc segments. Beginning at the inflection point 134 (from right to left) on interior surface 56 for discussion, coming upward around the lip 52 in a counter-clockwise (leftward) direction, the first convex arc segment “I” may have a relatively gentle curvature described as having a theoretical radius of about 0.131 units (such as inches, for example). The next convex arc segment “II” may have a relatively smaller or tighter curvature described as having a theoretical radius of about 0.087 units. The next convex arc segment “III” may have a relatively smaller or tighter curvature described as having a theoretical radius of about 0.062 units. The next convex arc segment “IV” may have a relatively smaller or tighter curvature described as having a theoretical radius of about 0.044 units.

In an exemplary embodiment, a relatively straight segment “V” contains the inflection point 132, and the groove 46 to the left of the segment “V” as illustrated has concave curvatures that are smallest or tightest near the straight segment “VI” and are more gradual extending out to the interior surface 60 of flange 130. In an exemplary embodiment, there is no undercut (no rightward depression at segments “V” or “VI”) to prevent a void that may not fill with liner material.

Inflection point 132 marks the transition between the convex curves of arc segments “I-IV” and the concave curves of arc segments “VI-IX.” Each of the arc segments “VI-IX” also covers 45 degrees, though only the center of each of the arc segments “VI-IX” is indicated with an arrow for simplicity. Below inflection point 132, the first concave arc segment “VI” may have a relatively tight curvature described as having a theoretical radius of about 0.066 units (such as inches, for example). The next concave arc segment “VII” may have a relatively larger or looser curvature described as having a theoretical radius of about 0.079 units. The next concave arc segment “VIII” may have a relatively larger or looser curvature described as having a theoretical radius of about 0.097 units. The next concave arc segment “IX” may have a relatively larger or looser curvature described as having a theoretical radius of about 1.306 units.

The described contours are very similar to a theoretical golden spiral, which is a logarithmic spiral that gets wider by a factor of the golden ratio for every quarter turn it takes. The golden ratio is a mathematical expression that is based on the Fibonacci sequence, where each term is the sum of the previous two terms. The golden ratio is approximately 1.618 to 1.

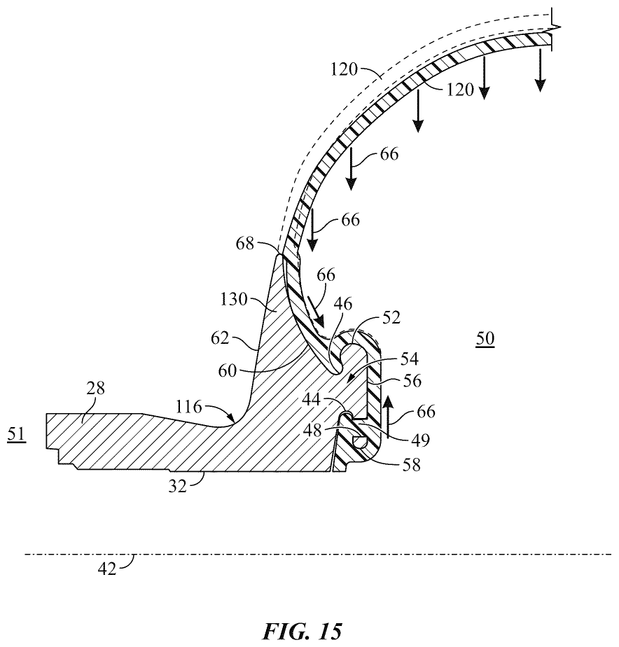

FIG. 15 is a partial cross-sectional view of a roto-molded liner 120 and boss 116. As liner 120 fully cures, radial shrinkage of the liner occurs, designated by arrows 66. This results in elevated contact pressure between liner 120 and boss 116 at the top of lip 52 as illustrated. This tight contact enhances sealing between liner 120 and the interior surfaces 56, 60 of the boss 116. Thus, high pressure sealing capability is achieved with the structure of the described boss 116 without the need for an auxiliary seal such as an O-ring or the complex two-part bosses often used with such O-rings. It has been found that the geometry of the substantially logarithmic structure of boss 116c FIGS. 10 and 11 may lead to desirably greater contact pressure in the primary seal area around lip 52 than the constant radius structures of bosses 116a and 116b.

Exemplary, non-limiting embodiments of a boss 116 and an assembly are described. In one aspect, a boss 116 is configured for attachment to a liner 120 of a pressure vessel 110. The boss comprises a port 32, a neck 28 and a flange 130. The port 32 has a longitudinal axis 42 and is configured to connect an interior 50 of the pressure vessel and an exterior 51 of the pressure vessel 110. The neck 28 circumscribes an exterior portion of the port 32. The flange 130 circumscribes an interior portion of the port 32 and extends radially outward from the neck 28. The flange 130 comprises an outer edge 68 at a farthest radial extent from the longitudinal axis 42; an exterior side disposed on a first side of the outer edge 68; and an interior side disposed on an opposed second side of the outer edge 68. The interior side comprises a first radially inner annular groove 44 and a second radially outer annular groove 46 positioned at a greater distance from the longitudinal axis 42 than the first radially inner annular groove 44. The first radially inner annular groove 44 has a first width D at its first base and a second width E at its first opening, wherein the second width E is equal to or greater than the first width D. The second radially outer annular groove 46 has a third width D at its second base and a fourth width E at its second opening, wherein the fourth width E is equal to or greater than the third width D.

In an exemplary embodiment, the interior side of the flange 130 comprises a ridge 54. In an exemplary embodiment, the ridge 54 comprises a first interior surface 56 of the boss 116; a first wall 140 of the first radially inner annular groove 44; a first radially inner lip 58 connecting the first interior surface 56 of the boss and the first wall 140; a second wall 142 of the second radially outer annular groove 46; and a second radially outer lip 52 connecting the first interior surface 56 of the boss 116 and the second wall 142. In an exemplary embodiment, the first interior surface 56 of the boss 116 is substantially perpendicular to the longitudinal axis 42. In an exemplary embodiment, the interior side of the flange comprises a plurality of apertures 48 that extend between the first interior surface 56 of the boss 116 and the first wall 140. In an exemplary embodiment, a radial dimension A of at least one of the plurality of apertures 48 is less than or equal to about twice the first width.

In an exemplary embodiment, a second interior surface 60 extends between the outer edge 68 and the second base of groove 46, wherein the second base has a concave curvature. Referring to FIG. 11, in an exemplary embodiment, a first radius of curvature of a first arc section (any one of VI, VII, VIII or IX) of the concave curvature is different from a second radius of curvature of a second arc section of the concave curvature (any other one of VI, VII, VIII or IX). In an exemplary embodiment, the first arc section is proximate the second wall 142; the second arc section is proximate the second interior surface 60; and the first radius of curvature is smaller than the second radius of curvature. In an exemplary embodiment, the concave curvature is substantially logarithmic.

In an exemplary embodiment, the second radially outer lip 52 has a convex curvature. In an exemplary embodiment, a first radius of curvature of a first arc section (any one of I, II, III or IV) of the convex curvature is different from a second radius of curvature of a second arc section of the convex curvature (any other one of I, II, III or IV). In an exemplary embodiment, the first arc section is proximate the first interior surface 56; the second arc section is proximate the second wall 142; and the first radius of curvature is greater than the second radius of curvature. In an exemplary embodiment, the convex curvature is substantially logarithmic.

In an exemplary embodiment, a width dimension of the first radially inner annular groove remains constant or increases continuously from the first width D at its first base to the second width E at its first opening; the width dimension of the first radially inner annular groove does not decrease as one measures from the first base toward the first opening.

In an exemplary embodiment, an assembly comprises a liner 120 comprising a first opening and first boss 116 attached to liner 120 at the first opening (see FIG. 9). In an exemplary embodiment, a composite shell 18 is disposed on the liner 120 and on the exterior side of the flange 130. In an exemplary embodiment, the liner 120 comprises a second opening, and the assembly comprises a second boss 116 attached to the liner 120 at the second opening (see FIG. 8). In an exemplary embodiment, the liner 120 is formed by rotational molding. In an exemplary embodiment, the liner 120 has a substantially uniform thickness. In an exemplary embodiment, the liner 120 comprises an anchor 49 disposed proximate the first radially inner annular groove 44, wherein the anchor 49 extends through an aperture 48 on an interior side of the flange 130.

Although the subject of this disclosure has been described with reference to several embodiments, workers skilled in the art will recognize that changes may be made in form and detail without departing from the scope of the disclosure. All features described with reference to one embodiment are also applicable to other embodiments unless otherwise stated.

1. A boss configured for attachment to a liner of a pressure vessel, the boss comprising:
a port having a longitudinal axis, the port configured to connect an interior of the pressure vessel and an exterior of the pressure vessel;
a neck that circumscribes an exterior portion of the port; and
a flange that circumscribes an interior portion of the port and that extends radially outward from the neck, wherein the flange comprises:
an outer edge at a farthest radial extent from the longitudinal axis;
an exterior side disposed on a first side of the outer edge; and
an interior side disposed on an opposed second side of the outer edge, the interior side comprising:
a first radially inner annular groove having a first width at its first base and a second width at its first opening, wherein the second width is equal to or greater than the first width; and
a second radially outer annular groove positioned at a greater distance from the longitudinal axis than the first radially inner annular groove, the second radially outer annular groove having a third width at its second base and a fourth width at its second opening, wherein the fourth width is equal to or greater than the third width.

2. The boss of claim 1, wherein the interior side of the flange comprises a ridge comprising:
a first interior surface of the boss;
a first wall of the first radially inner annular groove;
a first radially inner lip connecting the first interior surface of the boss and the first wall;
a second wall of the second radially outer annular groove; and
a second radially outer lip connecting the first interior surface of the boss and the second wall.

3. The boss of claim 2, wherein the first interior surface of the boss is substantially perpendicular to the longitudinal axis.

4. The boss of claim 2, wherein the interior side of the flange comprises a plurality of apertures that extend between the first interior surface of the boss and the first wall.

5. The boss of claim 4, wherein a radial dimension of at least one of the plurality of apertures is less than or equal to about twice the first width.

6. The boss of claim 2, comprising a second interior surface that extends between the outer edge and the second base, wherein the second base has a concave curvature.

7. The boss of claim 6, wherein a first radius of curvature of a first arc section of the concave curvature is different from a second radius of curvature of a second arc section of the concave curvature.

8. The boss of claim 7, wherein:
the first arc section is proximate the second wall;
the second arc section is proximate the second interior surface; and
the first radius of curvature is smaller than the second radius of curvature.

9. The boss of claim 6, wherein the concave curvature is substantially logarithmic.

10. The boss of claim 2, wherein the second radially outer lip has a convex curvature.

11. The boss of claim 10, wherein a first radius of curvature of a first arc section of the convex curvature is different from a second radius of curvature of a second arc section of the convex curvature.

12. The boss of claim 11, wherein:
the first arc section is proximate the first interior surface;
the second arc section is proximate the second wall; and
the first radius of curvature is greater than the second radius of curvature.

13. The boss of claim 10, wherein the convex curvature is substantially logarithmic.

14. The boss of claim 10, wherein a width dimension of the first radially inner annular groove remains constant or increases continuously from the first width at its first base to the second width at its first opening.

15. An assembly comprising:
a liner comprising a first opening; and
a first boss attached to the liner at the first opening, the first boss comprising:
a port having a longitudinal axis, the port configured to connect an interior of a pressure vessel and an exterior of the pressure vessel;
a neck that circumscribes an exterior portion of the port; and
a flange that circumscribes an interior portion of the port and that extends radially outward from the neck, wherein the flange comprises:
an outer edge at a farthest radial extent from the longitudinal axis;
an exterior side disposed on a first side of the outer edge; and
an interior side disposed on an opposed second side of the outer edge, the interior side comprising:
a first radially inner annular groove having a first width at its first base and a second width at its first opening, wherein the second width is equal to or greater than the first width; and
a second radially outer annular groove positioned at a greater distance from the longitudinal axis than the first radially inner annular groove, the second radially outer annular groove having a third width at its second base and a fourth width at its second opening, wherein the fourth width is equal to or greater than the third width.

16. The assembly of claim 15 comprising a composite shell disposed on the liner and on the exterior side of the flange.

17. The assembly of claim 15, wherein the liner comprises a second opening, the assembly comprising a second boss attached to the liner at the second opening.

18. The assembly of claim 15, wherein the liner is formed by rotational molding.

19. The assembly of claim 15, wherein the liner has a substantially uniform thickness.

20. The assembly of claim 15, wherein the liner comprises:
an anchor disposed proximate the first radially inner annular groove;
wherein the anchor extends through an aperture on an interior side of the flange.
